(19) United States
(12) Patent Application Publication
(10) Pub. No.: US 2004/0071928 A1
(43) Pub. Date: Apr. 15, 2004

(54) Device for bagging bulk material

(76) Inventor: Ludger Nobbe, Hagen a T.W. (DE)

Correspondence Address: JACOBSON HOLMAN PLLC, 400 SEVENTH STREET N.W., SUITE 600, WASHINGTON, DC, 20004, US

(21) Appl. No.: 10/450,715

(22) PCT Filed: Feb. 18, 2002
(86) PCT No.: PCT/EP02/01803

(30) Foreign Application Priority Data
Mar. 5, 2001 (DE) 10110478.2
Apr. 9, 2001 (DE) 10117770.4

(51) Int. Cl. B32B 5/00

(52) U.S. Cl. 428/98

(57) ABSTRACT

The invention relates to a device for the sacking of bulk material with a product container for receiving bulk material, a filling funnel, and a dust filter. According to the invention, a separator is arranged upstream to the dust filter, which is connected to the filling funnel via a suction line. Furthermore, the separator for the extracted bulk material is connected to the product container.

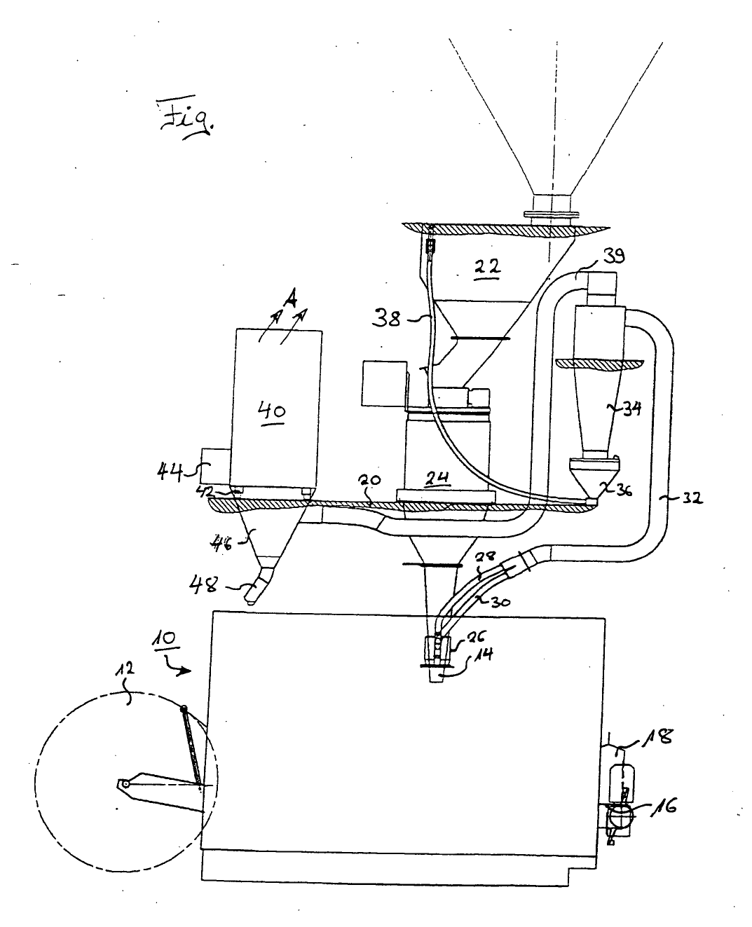

The invention relates to a device for the sacking of bulk material according to the generic term of claim 1.

Devices for the sacking of bulk material are already known. In such sacking units, sacks made of tubular film are fed to a filling funnel, filled, closed, and led away on a runout conveyor. A product container is assigned to the filling funnel, in which the bulk material to be filled is received. Normally, a scale is also arranged between the product container and the filling funnel, which determines the quantity to be filled into the sack. Known sacking units provide an extraction system in the area of the scale, which serves the purpose of extracting dusty bulk material together with the ambient air, and to feed the same to a dust filter. These dust filters usually consist of depth filters, i.e. fiber filters that are often arranged in multiple layers on top of each other.

Due to the fact that the bulk material to be filled is often changed in such sacking units, various material is collected in the depth filter so that usually no authentic material is present after cleaning the dust filter, which can be re-fed to the products to be filled. The solids extracted during the periodic cleaning of the dust filter must therefore be discarded on a regular basis in such known sacking units.

It is the task of the invention to embody a sacking unit for bulk material according to the generic term, in that the bulk material portion extracted during the sacking process can be regained at least for the largest part.

This task is solved according to the invention by means of the combination of the characteristics of claim 1.

Accordingly, in a device for the sacking for bulk material with a product container for receiving the bulk material, a filling funnel, and a dust filter, a separator is arranged upstream to the dust filter, which is connected to the filling tunnel by means of a suction line. The separator is then preferably connected to the product container by means of a conveyor line for the extracted bulk material.

According to this solution, the dust created during the filling of bulk material in the area of the pouring funnel is gathered immediately, and fed to a separator via the suction line, which according to a particularly advantageous embodiment of the invention may be a cyclone. The proportion of coarse solids is intercepted in the separator, while the proportion of fine solids is fed together with the air to the dust filter for the interception in the depth filters contained therein. The intercepted bulk material is fed from the separator back to the product container via a conveyor line, where the authentic material may be added to the bulk material to be filled.

Additional advantages of the invention are obvious from the sub-claims arising from the main claim. Any details and advantages of the invention are also obvious from the embodiment example described as follows, and in the only figure.

The figure schematically shows a sacking unit.

The sacking unit, which is conventionally constructed, is generally equipped with the reference number 10. Here, tubes are separated from a tubular film roll 12 in a manner not explained in further detail, which are sealed at one end in order to form a sack. The respective sacks are hung underneath a filling funnel 14 for the filling with bulk material. After the filling, the sacks 18 are sealed at a sealing station, and subsequently led away via a runout conveyor 16. The filling funnel 14 is an integral part of the sacking unit 10. A product container 22 for receiving the bulk material to be filled is arranged over the filling funnel. From there, the bulk material is fed to the filling funnel for the filling of sacks 18 not illustrated in detail via a scale 24.

A suction hood 26 is arranged on the filling funnel 14 above the area where the sacks 18 are hung. Suction lines 28 and 30 connect to the suction hood 26, which end in a mutual line 32. The line 32 extends tangentially into a cyclone 34, which has an intercepting tank 36 for receiving the extracted bulk material. From this intercepting tank 36, a supply line 38 for the extracted bulk material extends to the product container 22. The extracted authentic bulk material can be fed to the product container 22 via this supply line.

A suction line 39 is connected at the upper end of the cyclone 34, which feeds the supply air, and the not-extracted proportion of fine solids of the bulk material to a dust filter 40. The dust filter is elevated on the platform 20 via feet 42. Several filter layers are arranged on top of each other in the dust filter. The purified air flows into the direction of arrow A from the dust filter, while the proportion of fine solids of the bulk material is retained in the filter pads.

In order to be able to clean the filter pads, a vibrating motor 44 is attached to the dust filter 40, which actuates the entire dust filter into vibrating motions so that the extracted dust partially falls into a funnel 46 that is attached underneath the dust filter, from which this waste material can be extracted via a waste material outlet 48. Due to the fact that the filter pads of the dust filter 40 should not be exchanged with each product change, it cannot be prevented for various different products to get into the funnel 46 during the vibrating motion of the dust filter 40 so that the extracted material cannot be fed to the product container 22.

This illustrated embodiment example describes a cyclone 34 as a pre-separator. Depending on the product specification of the bulk material, however, other separators, such as deflection separators, etc. are also suitable as pre-separators.

1. Device for the sacking of bulk material with a product container for receiving bulk material, a filling funnel, and a dust filter, characterized that
a separator is arranged upstream to the dust filter, which is connected to the filling funnel via a suction line, and that the separator for the extracted bulk material is connected to the product container.

2. Device according to claim 1, characterized that the separator is a cyclone.

3. Device according to claim 1 or 2, characterized that a scale for the weighing of the bulk material is arranged between the product container and the filling funnel.

4. Device according to one of the claims 1 to 3, characterized that the dust filter is a depth filter.

5. Device according to one of the claims 1 to 4, characterized that the dust filter has a vibrating motor for the rough cleaning of the extracted bulk material.

6. Device according to one of the claims 1 to 5, characterized that the separator for the extracted bulk material is connected to the product container via a supply line.
